(19) United States
(12) Patent Application Publication
(10) Pub. No.: US 2026/0202910 A1
(43) Pub. Date: Jul. 16, 2026

(54) INTERACTION METHOD, HEAD-MOUNTED DISPLAY DEVICE AND NON-TRANSITORY COMPUTER-READABLE STORAGE MEDIUM

(71) Applicant: HTC Corporation, Taoyuan City (TW)

(72) Inventor: Wei-Fan CHEN, Taoyuan City (TW)

(21) Appl. No.: 19/023,378

(22) Filed: Jan. 16, 2025

(51) Int. Cl. G06F 3/01; G02B 27/00; G02B 27/01; G06T 7/579; G06T 13/40

(52) U.S. Cl. CPC G06F 3/012; G02B 27/0093; G02B 27/0101; G02B 27/017; G06T 7/579; G06T 13/40; G02B 2027/0138; G02B 2027/014

(57) ABSTRACT

An interaction method includes following steps. A head movement trajectory and a body movement trajectory are tracked. A physical action is recognized according to a relative movement between the head movement trajectory and the body movement trajectory. A posture classification of the physical action is identified. A virtual magnitude corresponding to the physical action is adjusted according to the posture classification. Interaction effects between a virtual environment and a real environment are rendered according to the virtual magnitude after adjustment.

### BACKGROUND

### Field of Invention

The disclosure relates to an interaction method and a head-mounted display device in an immersive system. More particularly, the disclosure relates to the interaction method about adjusting a sensitivity of movement tracking in the immersive system.

### Description of Related Art

In recent years, virtual reality has gained significant traction across various applications, from gaming and training simulations to remote operating systems. Despite advancements, a persistent challenge remains in providing users with a seamless and intuitive experience that effectively bridges the gap between physical and virtual worlds. Current systems often lack the ability to precisely track and interpret complex physical gestures, thus limiting the user's immersive experience and the efficiency of interactions within a virtual environment.

When a user wearing a head-mounted display (HMD) device, the visions of the user will be covered by the immersive content shown on the head-mounted display device. In some cases, the user may hold a hand-held controller as an input device. In order to provide an immersive experience to the user, it is required to track movements of the hand-held controller and the head-mounted display device. Based on tracking results, the head-mounted display device can render the immersive content accordingly, so as to fulfill interactions between a virtual world and a real world.

### SUMMARY

The disclosure provides an interaction method, which includes following steps. A head movement trajectory and a body movement trajectory are tracked. A physical action is recognized according to a relative movement between the head movement trajectory and the body movement trajectory. A posture classification of the physical action is identified. A virtual magnitude corresponding to the physical action is adjusted according to the posture classification. Interaction effects between a virtual environment and a real environment are rendered according to the virtual magnitude after adjustment.

The disclosure provides a head-mounted display device, which include a displayer and a processor. The displayer is configured to display a virtual environment. The process is coupled to the displayer. The processor is configured to track a head movement trajectory and a body movement trajectory. The processor is configured to recognize a physical action according to a relative movement between the head movement trajectory and the body movement trajectory. The processor is configured to identify a posture classification of the physical action. The processor is configured to adjust a virtual magnitude corresponding to the physical action according to the posture classification. The processor is configured to render interaction effects between a virtual environment and a real environment according to the virtual magnitude after adjustment.

The disclosure provides a non-transitory computer-readable storage medium, storing at least one instruction program executed by a processor to perform an interaction method, which includes following steps. A head movement trajectory and a body movement trajectory are tracked. A physical action is recognized according to a relative movement between the head movement trajectory and the body movement trajectory. A posture classification of the physical action is identified. A virtual magnitude corresponding to the physical action is adjusted according to the posture classification. Interaction effects between a virtual environment and a real environment are rendered according to the virtual magnitude after adjustment.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating an immersive system according to an embodiment of this disclosure.

FIG. 2 is a schematic diagram illustrating the head-mounted display device, some body-mounted trackers and the hand-held controller located in a real environment according to an embodiment of this disclosure.

FIG. 3 is a flow chart illustrating an interaction method according to some embodiments of the disclosure.

FIG. 4 is a flow chart diagram illustrating the interaction method in a demonstrational example.

FIG. 5A and FIG. 5B are schematic diagrams illustrating an interaction between the real environment and the virtual environment while the physical action is identified as the first posture.

FIG. 6A and FIG. 6B are schematic diagrams illustrating an interaction between the real environment and the virtual environment while the physical action is identified as the second posture.

FIG. 7A and FIG. 7B are schematic diagrams illustrating an interaction between the real environment and the virtual environment while the physical action is identified as the third posture.

FIG. 8A and FIG. 8B are schematic diagrams illustrating an interaction between the real environment and the virtual environment while the physical action is identified as the fourth posture.

FIG. 9 is a flow chart illustrating an interaction method according to some embodiments of the disclosure.

FIG. 10 is a flow chart illustrating an interaction method according to some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

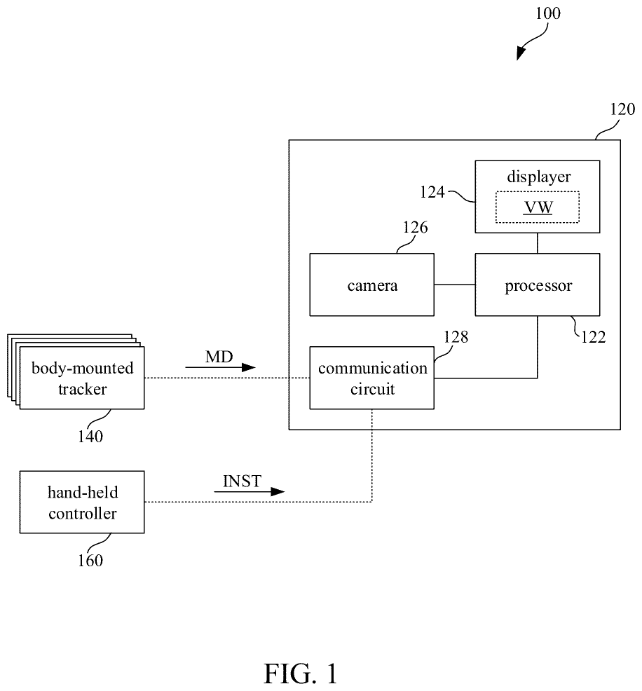

Reference is made to FIG. 1, which is a schematic diagram illustrating an immersive system 100 according to an embodiment of this disclosure. As shown in FIG. 1, the immersive system 100 includes a head-mounted display (HMD) device 120, at least one body-mounted tracker 140 and a hand-held controller 160. As shown in FIG. 1, the head-mounted display device 120 may include a processor 122, a displayer 124, a camera 126 and a communication circuit 128. The displayer 124 is configured to display a virtual environment VW to the user.

The processor 122 can be implemented by a central processing unit (CPU), a graphic processing unit (GPU), a tensor processing unit (TPU), an application-specific integrated circuit (ASIC) or similar component. The displayer 124 can be implemented by using high-resolution OLED or LCD panels, providing vibrant colors and wide viewing angles. It integrates with lenses to project immersive 3D visuals, ensuring a seamless virtual reality experience by adjusting focus and depth perception dynamically. The camera 126 can be implemented by a CMOS image sensor, CCD image sensor, a depth camera or similar component. The communication circuit 128 can be implemented by a WiFi transceiver circuit, a Bluetooth transceiver or similar component.

In order to provide an immersive experience to the user UR, the immersive system 100 is configured to track a physical movement of the user, and provide an interaction between user's physical movement and the virtual environment VW.

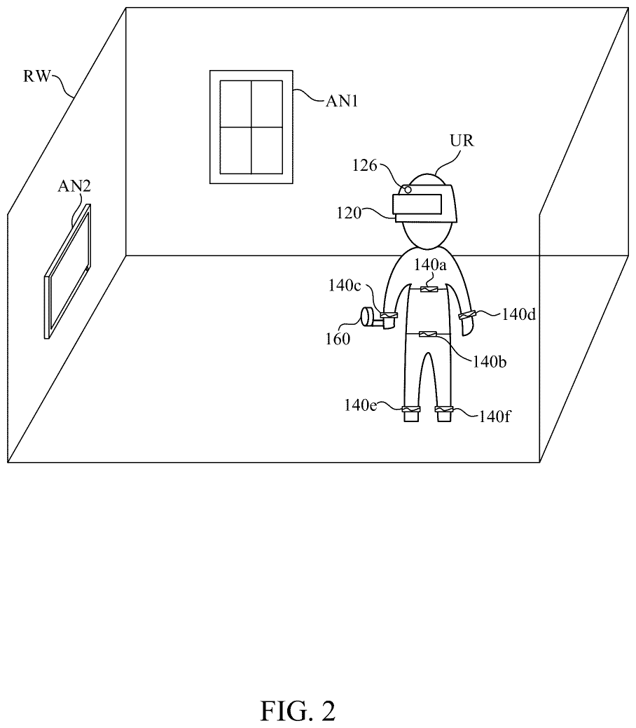

Reference is further made to FIG. 2, which is a schematic diagram illustrating the head-mounted display device 120, some body-mounted trackers 140a~140f and the hand-held controller 160 located in a real environment RW according to an embodiment of this disclosure.

For example, the real environment RW as shown in FIG. 2 can be an indoor space (e.g., a bedroom or a conference room) in a real world, but the disclosure is not limited thereto. In some other embodiments, the real environment RW can also be a specific area at an outdoor space (not shown in figures). On the other hand, the head-mounted display device 120 is configured to display a virtual environment VW to the user UR.

As shown in FIG. 2, the head-mounted display device 120 can be worn on the head of the user UR. In some embodiments, the camera 126 of the head-mounted display device 120 can be configured to capture streaming images. The processor 122 is coupled with the camera 126, and the processor 122 is able to run a simultaneous localization and mapping (SLAM) algorithm to track the head movement trajectory based on the streaming images.

For example, the streaming images may cover some anchor items AN1 (e.g., a window) and AN2 (e.g., a television) in the real environment RW as shown in FIG. 2. In most cases, positions of the anchor items AN1 and AN2 are fixed in the real environment RW. The simultaneous localization and mapping algorithm executed by the processor 122 may keep tracking a gap distance between the head-mounted display device 120 and the anchor item AN1, and also keep tracking another gap distance between the head-mounted display device 120 and the anchor item AN2. Therefore, the processor 122 is capable of obtaining a position (and/or a rotation) of the head-mounted display device 120 relative to these anchor items AN1 and AN2. In this case, the processor 122 is able to track the head movement trajectory of the user UR.

The body-mounted tracker(s) 140 can be attached on a torso, a hand or a leg of the user UR. In some embodiments, the body-mounted tracker(s) 140 is able to generate motion data MD. For example, the body-mounted tracker(s) 140 can include a gyro sensor and/or an accelerator sensor for generating the motion data MD. The motion data MD generated by the body-mounted tracker(s) 140 is transmitted through the communication circuit 128 to the processor 122 of the head-mounted display device 120. The processor 122 is able to track a body movement trajectory based on the motion data MD.

In some other embodiments, the body movement trajectory can be tracked by the camera 126 of the head-mounted display device 120 integrated with a computer vision algorithm. For example, the computer vision algorithm can be executed to recognize positions and movements of the body-mounted tracker(s) 140 in view of the camera 126, so as to track the body movement trajectory.

As shown in FIG. 2, there are six body-mounted trackers 140a~140f attached on different positions of the user UR.

The body-mounted trackers 140a and 140b (utilized as torso trackers) provide data on upper body movements, including bending, twisting, and leaning. The body-mounted trackers 140a and 140b are particularly effective for detecting postures like leaning forward.

The body-mounted trackers 140c and 140d (utilized as hand trackers) are attached to the user's wrists or hands. The body-mounted trackers 140c and 140d capture fine motor skills and gestures. They are essential for recognizing actions such as clenching a fist or positioning hands for typing.

The body-mounted trackers 140e and 140f (utilized as leg trackers) are placed on the thighs or ankles. Leg trackers monitor lower body movements such as walking, running, or jumping. This data is vital for amplifying actions like running in place within a virtual environment.

The positions and the total amount of the body-mounted trackers 140a~140f illustrated in FIG. 2 are provided as a demonstrational example. However, the disclosure is not limited thereto. The body-mounted trackers in this disclosure are not limited to be mounted on these six positions. In some other embodiments, the body-mounted tracker(s) 140 in the immersive system 100 include one of the body-mounted trackers 140a~140f or a partial combination of the body-mounted trackers 140a~140f.

In some embodiments, the processor 122 is able to integrate the body movement trajectory (obtained from the body-mounted tracker 140) with the head movement trajectory (obtained via SLAM technology), so as to form a cohesive understanding of physical actions performed by the user UR. By accurately capturing diverse physical activities across different body parts, the user UR may experience more immersive and responsive applications tailored specifically towards enhancing realism while maintaining intuitive control over their digital avatars'actions.

The physical actions performed by the user UR in the real environment RW may be limited by some conditions, such as there is not enough space for the user UR to run in an indoor space, or normally user can't run faster than a leopard. In some embodiments, the immersive system 100 would like to provide an immersive experience which can exceed the limitation of the real environment RW. Following the detection of the physical actions, the disclosure offers customizable movement modes for navigating virtual worlds. Users can opt to amplify real-world movement distances within the virtual environment, achieving an extended operational range. Users can opt to reduce real-world movement distances within the virtual environment, achieving an precise operational accuracy. Users can instantly select and switch between different movement modes through control devices such as controllers or gestures. This selection can be made in real-time, allowing adjustment of the magnitude of movement in the virtual world according to the application's needs. This feature's technical advantage lies in the system's multimodal movement definition and its instantaneous control and switching capabilities, providing a highly flexible and dynamic interaction experience. Further details are explained in following embodiments.

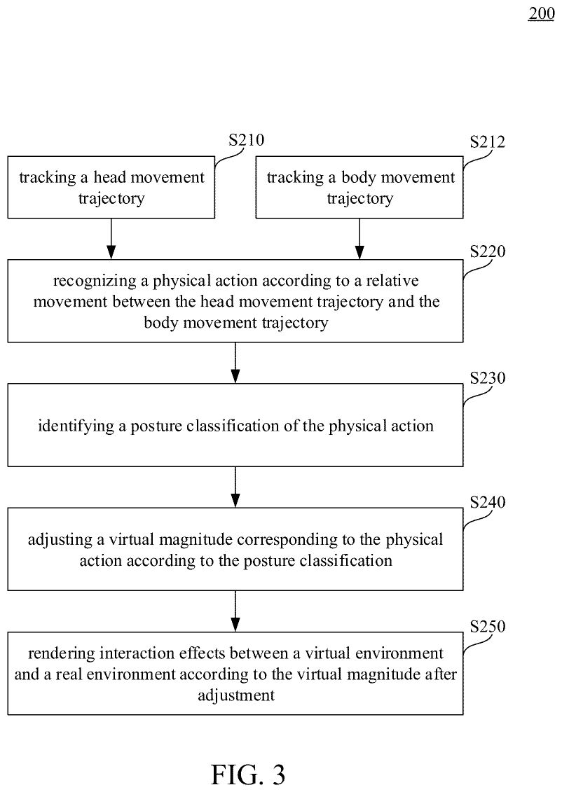

Reference is further made to FIG. 3, which is a flow chart illustrating an interaction method 200 according to some embodiments of the disclosure. The interaction method 200 can be executed by the head-mounted display device 120 of the immersive system 100 shown in FIG. 1 and FIG. 2.

Step S210 is executed by the processor 122 to track a head movement trajectory. In some embodiments, the processor 122 execute the simultaneous localization and mapping (SLAM) algorithm based on the streaming images captured by the camera 126 to track the head movement trajectory.

Step S212 is executed by the processor 122 to track a body movement trajectory. In some embodiments, the processor 122 executes the computer vision algorithm based on the streaming images (which involves positions and movements of the body-mounted trackers 140a~140f in view of the camera 126) to track the body movement trajectory.

Step S220 is executed by the processor 122 to recognize a physical action according to a relative movement between the head movement trajectory and the body movement trajectory. The physical action can be recognized by comparing these two trajectories to identify specific patterns indicative of certain physical actions. In some embodiments, the processor 122 continuously monitors the alignment between head and body movements. For example, if both trajectories move synchronously in a forward direction, it may indicate walking or running. If the head turns while the body remains stationary, it suggests looking around without moving. In some embodiments, the processor 122 continuously analyzes changes in speed and acceleration between head and body movements. For example, a rapid increase in head velocity compared to body velocity might indicate nodding or shaking. A sudden stop in body movement with continued head motion could suggest a pause to observe surroundings. In some embodiments, the processor 122 measures positional offsets between head and body over time. A consistent forward lean detected by a greater forward offset of the torso relative to the head suggests leaning forward. An upward trajectory of both head and torso followed by a downward motion could indicate jumping.

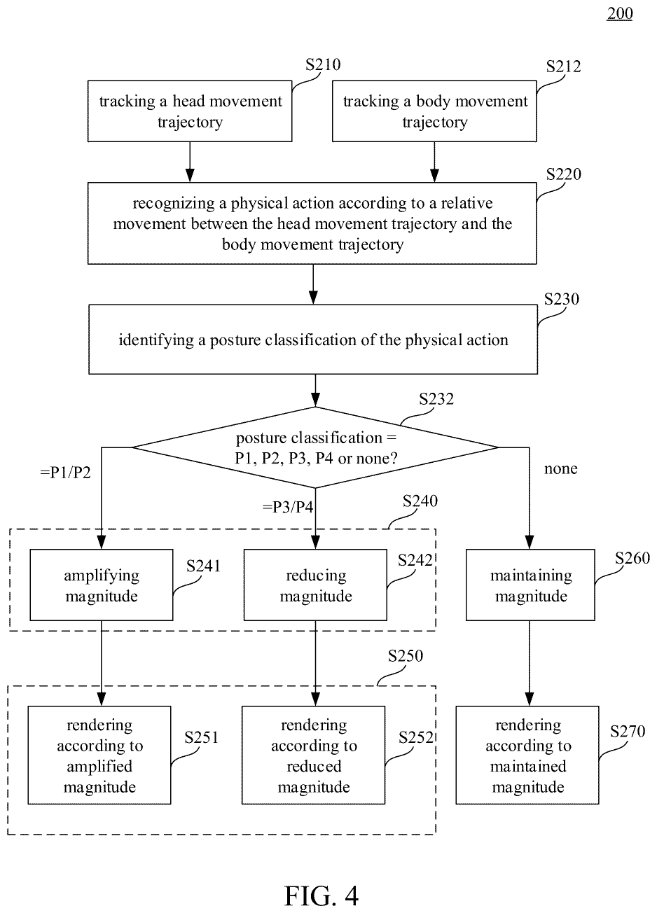

Step S230 is executed by the processor 122 to identify a posture classification of the physical action, based on the physical action detected in step S220. Reference is further made to FIG. 4, which is a flow chart diagram illustrating the interaction method 200 in a demonstrational example. Some posture classifications are discussed in the demonstrational example. However, the disclosure in not limited thereto.

In the demonstrational example shown along FIG. 4, the posture classification can include a first posture P1 of leaning forward and running, a second posture P2 of jumping, a third posture P3 of clenching a fist, and a fourth posture P4 of positioning hands for typing. As shown in FIG. 4, the interaction method 200 further include step S232, which is performed by the processor 122, to determine whether the physical action matches with either one of the first posture P1, the second posture P2, the third posture P3, the fourth posture P4 or not.

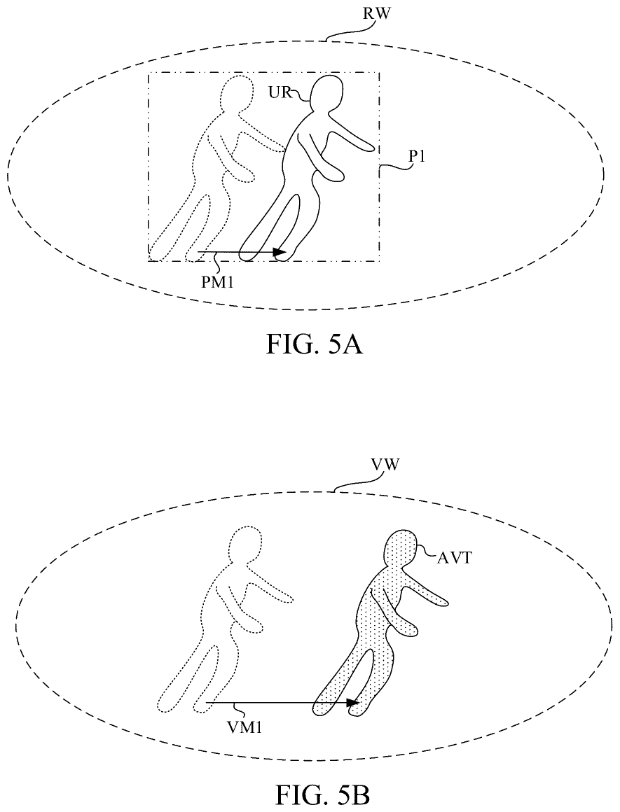

If the physical action is identified as the first posture P1, step S241 is executed, by the processor 122, to amplify a physical magnitude of the physical action to decide the virtual magnitude. Reference is further made to FIG. 5A and FIG. 5B, which are schematic diagrams illustrating an interaction between the real environment RW and the virtual environment VW while the physical action is identified as the first posture P1 of leaning forward and running.

As shown in FIG. 4, FIG. 5A and FIG. 5B, when the physical action of the user UR is identified as leaning forward and running (i.e., the first posture P1) in the real environment RW, step S241 is executed to amplify a physical magnitude PM1 of the physical action in the real environment RW, so as to decide a virtual magnitude VM1 in the virtual environment VW.

In this case, the virtual magnitude VM1 is larger than the physical magnitude PM1 according to an amplification ratio (e.g., 1.5×, 2×, 5× or 10×). In this case, an avatar AVT in the virtual environment VW can move by the virtual magnitude VM1 in the virtual environment VW. In this case, step S251 is executed by the processor 122 to render interaction effects between the virtual environment VR and the real environment RW according to the virtual magnitude VM1 after adjustment. In other words, when the user UR acts in the first posture P1 and moves by the physical magnitude PM1 in the real environment RW, the avatar AVT will be assigned to run forward with the virtual magnitude VM1 in the virtual environment VW. The amplification of the virtual magnitude VM1 allows the avatar AVT to move faster and reach an extended operational range in the virtual environment VW.

In aforesaid embodiment, the virtual magnitude VM1 (amplified from the physical magnitude PM1) as shown in FIG. 5B corresponds to a virtual displacement distance amplified from a physical displacement distance. However, the virtual magnitude is not limited thereto. In some other embodiments, the virtual magnitude corresponds to a virtual rotation, a virtual moving speed, a virtual acceleration or a virtual moving sensitivity amplified from a physical rotation, a physical moving speed, a physical acceleration or a physical moving sensitivity.

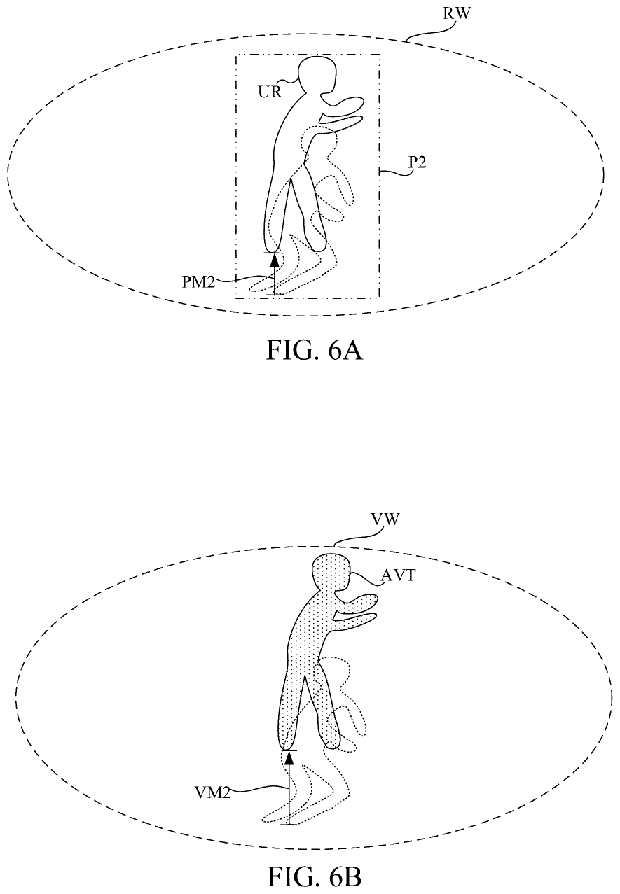

In some embodiments, if the physical action is identified as the second posture P2, step S241 is executed, by the processor 122, to amplify a physical magnitude of the physical action to decide the virtual magnitude. Reference is further made to FIG. 6A and FIG. 6B, which are schematic diagrams illustrating an interaction between the real environment RW and the virtual environment VW while the physical action is identified as the second posture P2 of jumping.

As shown in FIG. 4, FIG. 6A and FIG. 6B, when the physical action of the user UR is identified as jumping (i.e., the second posture P2) in the real environment RW, step S241 is executed to amplify a physical magnitude PM2 of the physical action in the real environment RW, so as to decide a virtual magnitude VM2 in the virtual environment VW.

In this case, the virtual magnitude VM2 is larger than the physical magnitude PM2 according to an amplification ratio (e.g., 1.5×, 2×, 5× or 10×). In this case, an avatar AVT in the virtual environment VW can jump by the virtual magnitude VM2 in the virtual environment VW. In this case, step S251 is executed by the processor 122 to render interaction effects between the virtual environment VR and the real environment RW according to the virtual magnitude VM2 after adjustment. In other words, when the user UR acts in the second posture P2 and moves by the physical magnitude PM2 in the real environment RW, the avatar AVT will be assigned to jump upward with the virtual magnitude VM2 in the virtual environment VW. The amplification of the virtual magnitude VM2 allows the avatar AVT to jump higher and reach an extended operational range in the virtual environment VW.

In some embodiments, the virtual magnitude VM2 (amplified from the physical magnitude PM2) corresponds to a virtual displacement distance, a virtual rotation, a virtual moving speed, a virtual acceleration or a virtual moving sensitivity.

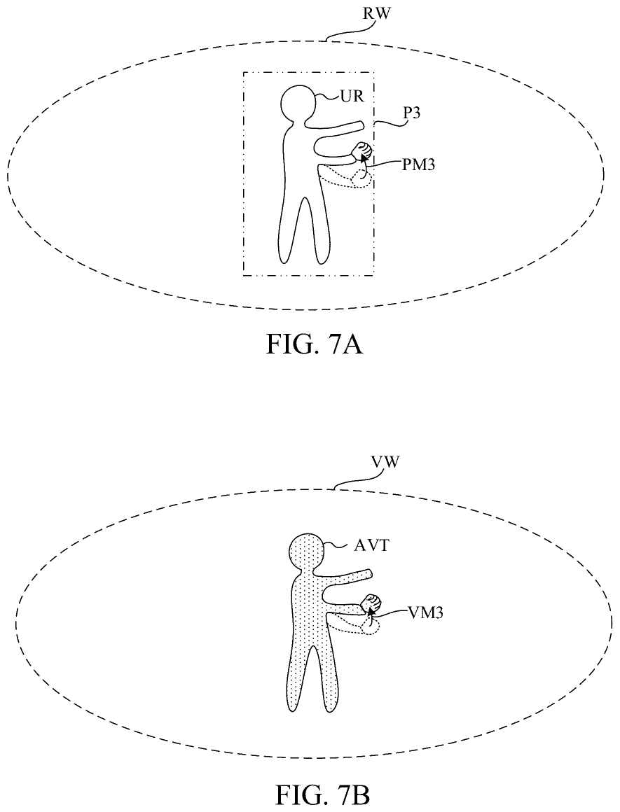

In some embodiments, if the physical action is identified as the third posture P3, step S242 is executed, by the processor 122, to reduce a physical magnitude of the physical action to decide the virtual magnitude. Reference is further made to FIG. 7A and FIG. 7B, which are schematic diagrams illustrating an interaction between the real environment RW and the virtual environment VW while the physical action is identified as the third posture P3 of clenching a fist.

As shown in FIG. 4, FIG. 7A and FIG. 7B, when the physical action of the user UR is identified as clenching a fist (i.e., the third posture P3) in the real environment RW, step S242 is executed to reduce a physical magnitude PM3 of the physical action in the real environment RW, into a virtual magnitude VM3 in the virtual environment VW.

In some embodiments, the third posture P3 is identified based on the head movement trajectory and the body movement trajectory, and also in reference with an input from the hand-held controller 160. For example, the hand-held controller 160 may include a pressure sensor (or a sensing button) implemented on a surface of hand-held area of the hand-held controller 160. When the user grasps the hand-held controller 160, the hand-held controller 160 may send a sensing signal to the processor 122, to indicate this grasp condition. The processor 122 can detect the third posture P3 based on the head movement trajectory, the body movement trajectory and the sensing signal.

In this case, the virtual magnitude VM3 is smaller than the physical magnitude PM3 according to a reduction ratio (e.g., 0.8×, 0.5'3 or 0.25×). In this case, an avatar AVT in the virtual environment VW can move or rotate the fist by the virtual magnitude VM3 in the virtual environment VW. In this case, step S252 is executed by the processor 122 to render interaction effects between the virtual environment VR and the real environment RW according to the virtual magnitude VM3 after adjustment. In other words, when the user UR acts in the third posture P3 and moves by the physical magnitude PM3 in the real environment RW, the avatar AVT will be assigned to move or rotate the fist with the virtual magnitude VM3 in the virtual environment VW. The reduction of the virtual magnitude VM3 allows the avatar AVT to move or rotate the fist more precisely or more accurately in the virtual environment VW. It can be useful when the user wants to select a target item/button among a lot of items in a virtual menu in the virtual environment VW. By reducing the virtual magnitude VM3, the avatar AVT can precisely point on the target item/button, without touching a surrounding item/button by mistakes.

In aforesaid embodiments, the virtual magnitude VM3 (reduced from the physical magnitude PM3) as shown in FIG. 7B corresponds to a virtual rotation reduced from a physical rotation. However, the virtual magnitude is not limited thereto. In some other embodiments, the virtual magnitude corresponds to a virtual displacement distance, a virtual moving speed, a virtual acceleration or a virtual moving sensitivity amplified from a physical displacement distance, a physical moving speed, a physical acceleration or a physical moving sensitivity.

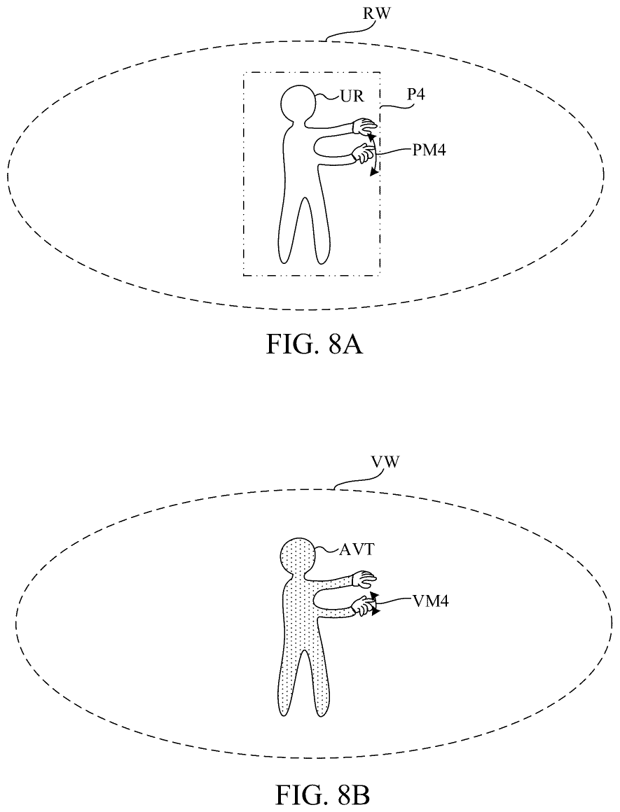

In some embodiments, if the physical action is identified as the fourth posture P4, step S242 is executed, by the processor 122, to reduce a physical magnitude of the physical action to decide the virtual magnitude. Reference is further made to FIG. 8A and FIG. 8B, which are schematic diagrams illustrating an interaction between the real environment RW and the virtual environment VW while the physical action is identified as the fourth posture P4 of typing.

As shown in FIG. 4, FIG. 8A and FIG. 8B, when the physical action of the user UR is identified as typing (i.e., the fourth posture P4) in the real environment RW, step S242 is executed to reduce a physical magnitude PM4 of the physical action in the real environment RW, so as to decide a virtual magnitude VM4 in the virtual environment VW.

In this case, the virtual magnitude VM4 is smaller than the physical magnitude PM4 according to a reduction ratio (e.g., 0.8×, 0.5× or 0.25×). In this case, an avatar AVT in the virtual environment VW can move or rotate the hands/fingers by the virtual magnitude VM4 in the virtual environment VW. In this case, step S252 is executed by the processor 122 to render interaction effects between the virtual environment VW and the real environment RW according to the virtual magnitude VM4 after adjustment. In other words, when the user UR acts in the fourth posture P4 and moves by the physical magnitude PM4 in the real environment RW, the avatar AVT will be assigned to move or rotate the hands/fingers with the virtual magnitude VM4 in the virtual environment VW. The reduction of the virtual magnitude VM4 allows the avatar AVT to move or rotate the hands/fingers more precisely or more accurately in the virtual environment VW. It can be useful when the user wants to click on a specific key on a virtual keyboard in the virtual environment VW. By reducing the virtual magnitude VM4, the avatar AVT can precisely press on the target key, without touching surrounding keys by mistakes.

In some embodiments, the virtual magnitude VM4 (reduced from the physical magnitude PM4) corresponds to a virtual displacement distance, a virtual rotation, a virtual moving speed, a virtual acceleration or a virtual moving sensitivity.

In some embodiments, advanced pattern recognition algorithms are employed in step S230 to match these observed relative movements against predefined templates for known actions. In some embodiments, the processor 122 further detects a current-running application, and obtains an action set matched with the current-running application. The action set includes some candidate postures while operating the current-running application. Then, the processor 122 selects the posture classification among the candidate postures.

For example, when the current-running application is a shooting game or a firefighting simulation, the action set matched with the current-running application may include the first posture P1, the second posture P2 and the third posture P3. The fourth posture P4 (i.e., typing) may not be included in this action set. Considering a virtual reality training simulation for firefighting, if the real-world posture shows a forward lean, this can recognized as running towards to the house on fire. During rescue operations requiring quick responses, simultaneous upward trajectories of both head and torso are recognized as jumping over debris or barriers.

For example, when the current-running application is a document processing application, the action set matched with the current-running application may include the third posture P3 and the fourth posture P4. The first posture P1 (i.e., running) and the second posture (i.e., jumping) may not be included in this action set.

As shown in FIG. 3, step S240 is executed by the processor 122 to adjust the virtual magnitude corresponding to the physical action according to the posture classification (referring to steps S241 and S242 discussed along with FIG. 4). Step S250 is executed by the processor 122 to render interaction effects between the virtual environment VW and the real environment RW according to the virtual magnitude after adjustment (referring to steps S251 and S252 discussed along with FIG. 4).

On the other hand, as shown in FIG. 4, when the physical action is not directed to aforesaid posture classifications to be amplified or to be reduced, step S260 is executed by the processor 122 to maintain the physical magnitude of the physical action, so as to decide the virtual magnitude (e.g., equal to the physical magnitude). Step S270 is executed by the processor 122 to render interaction effects between the virtual environment VW and the real environment RW according to the maintained magnitude. In this case, the avatar AVT in the virtual environment VW will move in the magnitude same as the physical action performed by the user UR in the real environment RW.

Aforesaid embodiments are applicable across various domains, including virtual reality gaming, virtual training systems, and remote operation systems. By enabling precise motion recognition and amplification, the immersive system 100 and the interaction method 200 allows users to interact with virtual environments more naturally and intuitively, achieving efficient connectivity between the real and virtual worlds. This enhancement significantly improves operational capabilities and overall user experience.

In aforesaid embodiments, the virtual magnitude is adjusted according to the posture classification of the physical action. However, the disclosure is not limited thereto. In some other embodiments, the immersive system 100 supports adjustment of the virtual magnitude according to a manual instruction INST received from the hand-held controller 160. The manual instruction INST is capable of switching between modes where users can choose desired amplification levels for their activities.

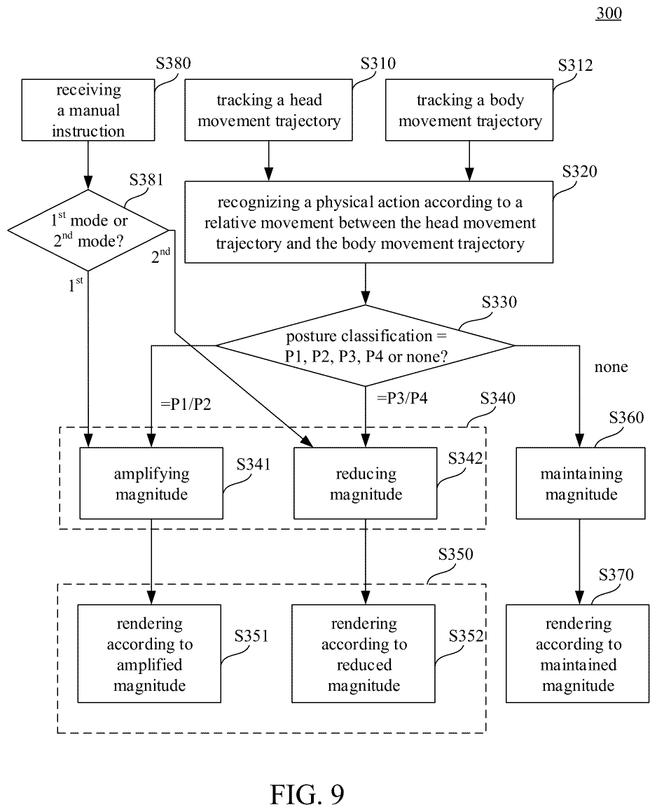

Reference is further made to FIG. 9, which is a flow chart illustrating an interaction method 300 according to some embodiments of the disclosure. The interaction method 300 can be executed by the processor 122 of the head-mounted display device 120 shown in FIG. 1. Steps S310, S312, S320, S330, S340, S341, S342, S350, S351, S352, S360 and S370 in FIG. 9 are similar to corresponding steps S210, S212, S220, S230, S240, S241, S242, S250, S251, S252, S260 and S270 discussed in FIG. 3 or FIG. 4. Details of these steps are not repeated again.

As shown in FIG. 9, the interaction method 300 further includes steps S380 and S381. In step S380, the processor 122 is configured to receive a manual instruction INST received from the hand-held controller 160. The manual instruction INST may indicate a first mode for amplifying the virtual magnitude or a second mode for reducing the virtual magnitude.

In some embodiments, the hand-held controller 160 may include a first button and a second button. When the user presses the first button, the hand-held controller 160 will generate the manual instruction INST indicating the first mode. When the user presses the second button, the hand-held controller 160 will generate the manual instruction INST indicating the second mode.

In some embodiments, the hand-held controller 160 may include a button. When the user single-clicks (or short presses) the button, the hand-held controller 160 will generate the manual instruction INST indicating the first mode. When the user double clicks (or press-and-holds) the button, the hand-held controller 160 will generate the manual instruction INST indicating the second mode.

The disclosure is not limited to aforementioned ways to generate the manual instruction INST. Various manners can be adopted on the hand-held controller 160 to generate the manual instruction INST with two different indications. Step S381 is executed by the processor 122 to determine whether manual instruction INST indicates the first mode or the second mode.

When the processor 122 receives the manual instruction INST, the processor 122 will detect whether the manual instruction INST indicates the first mode or the second mode.

If the manual instruction indicates the first mode, the interaction method 300 executed step S341 for amplifying the physical magnitude of the physical action to decide the virtual magnitude, and step S351 for rendering according to the amplified magnitude.

If the manual instruction indicates the second mode, the interaction method 300 executed step S342 for reducing the physical magnitude of the physical action to decide the virtual magnitude, and step S352 for rendering according to the reduced magnitude.

Based on aforesaid embodiments, the immersive system 100 and the interaction method 300 support manual instructions for switching between modes where users can choose desired amplification levels for their activities.

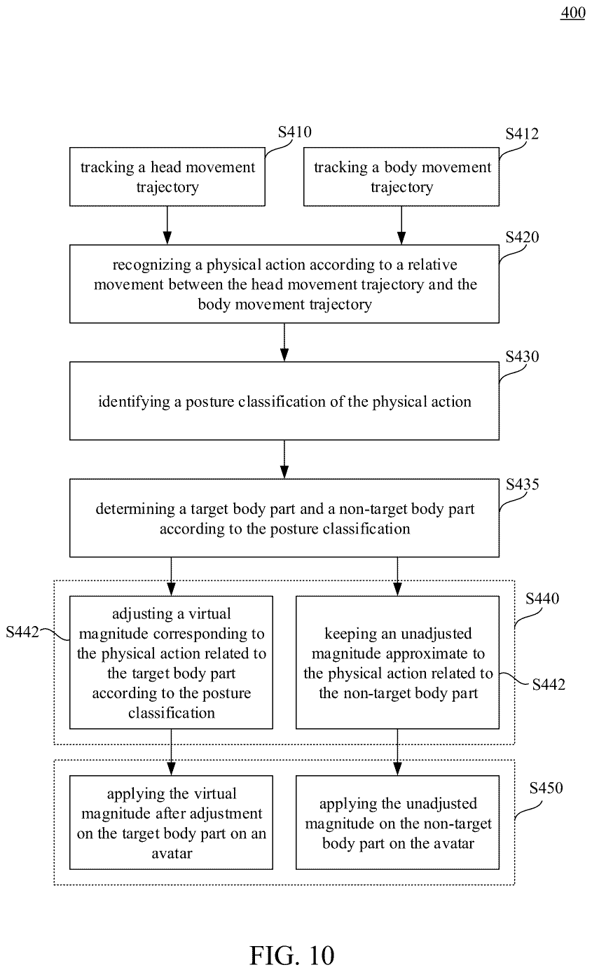

In some embodiments, the physical action of the user can include a combination of actions on different body parts. For example, the user may run forward and rotate his/her head at the same time. In this case, it is not suitable to adjust the magnitudes about these two actions (running and head-rotating) with the same ratio. Reference is further made to FIG. 10, which is a flow chart illustrating an interaction method 400 according to some embodiments of the disclosure. The interaction method 400 is able to apply different adjustments of magnitudes related to different body parts in reference with the posture classification.

Steps S410, S412, S420 and S430 as shown in FIG. 10 are similar to corresponding steps S210, S212, S220, S230 and S240 discussed in FIG. 3 or FIG. 4. Details of these steps are not repeated again.

After the posture classification of the physical action is identified, step S435 is executed by the processor 122 to determine a target body part and a non-target body part according to the posture classification.

As shown in FIG. 5A, FIG. 5B and FIG. 10, if the posture classification is identified as the first posture P1 of leaning forward and running, lower body parts (including legs or feet) are regarded as the target body part under the first posture P1. On the other hand, upper body parts (including torso, head, shoulder or hands) are regarded as the non-target body part under the first posture P1. Step S440 is executed by the processor 122 to adjust the virtual magnitude corresponding to the physical action according to the posture classification. In this embodiment, step S440 include steps S441 and S442. Step S441 is executed by the processor 122 to adjust the virtual magnitude corresponding to the physical action related to the target body part. In the embodiments shown in FIG. 5A and FIG. 5B, the physical magnitude PM1 of the physical action related to the target body part (e.g., legs or feet) is amplified into the virtual magnitude VM1. On the other hand, step S442 is executed by the processor 122 to keep an unadjusted magnitude approximate to the physical action related to the non-target body part. For example, if the physical action also include a head rotation (related to the non-target body part), a physical magnitude (not shown in figures) of the head rotation will be kept the same as the unadjusted magnitude.

Step S450 is executed by the processor 122 to render interaction effects between the virtual environment VW and the real environment RW according to the virtual magnitude after adjustment and the unadjusted magnitude. As shown in FIG. 5A, FIG. 5B and FIG. 10, step S451 is executed by the processor 122 to apply the virtual magnitude VM1 after adjustment on the target body part (e.g., legs or feet) on the avatar AVT. At the same time, step S452 is executed by the processor 122 to apply the unadjusted magnitude on the non-target body part on the avatar AVT.

In some embodiments, when the posture classification is identified as the first posture P1 of leaning forward and running, some movements (e.g., legs or feet) of the avatar AVT will be amplified and other movement (e.g., head or hands) will follow the original magnitude of the physical action related to the non-target body part. In other words, movements on different body parts will be treated differently.

A distribution of the target body part and the non-target body part will be different according to the posture classification. If the posture classification is identified as the second posture P2 of jumping as shown in FIG. 6A, lower body parts (including waist, legs or feet) are regarded as the target body part under the second posture P2. On the other hand, upper body parts (including head or shoulder) are regarded as the non-target body part under the second posture P2.

If the posture classification is identified as the fourth posture P4 of positioning hands for typing as shown in FIG. 8A, fists, fingers, palms are regarded as the target body part under the fourth posture P4. On the other hand, other body parts (e.g., legs, shoulder, torso, head) are regarded as the non-target body part under the fourth posture P4. In some embodiments, when the posture classification is identified as the fourth posture P4 of positioning hands for typing, some movements (e.g., fists, fingers, palms) of the avatar AVT will be reduced and other movement (e.g., legs, shoulder, torso, head) will follow the original magnitude of the physical action related to the non-target body part.

A non-transitory computer-readable storage medium is also disclosed. The non-transitory computer-readable storage medium stores at least one instruction program executed by a processor 122 to perform an interaction method 200 shown in FIG. 3 and FIG. 4, an interaction method 300 shown in FIG. 9 or an interaction method 400 shown in FIG. 10. The non-transitory computer-readable storage medium can be implemented by a storage unit (not shown) in the head-mounted display device 120 shown in FIG. 1.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An interaction method, comprising:
tracking a head movement trajectory and a body movement trajectory;
recognizing a physical action according to a relative movement between the head movement trajectory and the body movement trajectory;
identifying a posture classification of the physical action;
adjusting a virtual magnitude corresponding to the physical action according to the posture classification; and
rendering interaction effects between a virtual environment and a real environment according to the virtual magnitude after adjustment.

2. The interaction method of claim 1, wherein the head movement trajectory is tracked by a head-mounted display (HMD) device based on a simultaneous localization and mapping (SLAM) algorithm, and the body movement trajectory is tracked by a body-mounted tracker attached on a torso, a hand or a leg of a user, or the body movement trajectory is tracked by a camera of a head-mounted display (HMD) device integrated with a computer vision algorithm.

3. The interaction method of claim 1, wherein the posture classification comprises a first posture of leaning forward and running, and adjusting the virtual magnitude comprises:
in response to that the physical action is identified as the first posture, amplifying a physical magnitude of the physical action to decide the virtual magnitude.

4. The interaction method of claim 1, wherein the posture classification comprises a second posture of jumping, and adjusting the virtual magnitude comprises:
in response to that the physical action is identified as the second posture, amplifying a physical magnitude of the physical action to decide the virtual magnitude.

5. The interaction method of claim 1, wherein the posture classification comprises a third posture of clenching a fist, and adjusting the virtual magnitude comprises:
in response to that the physical action is identified as the third posture, reducing a physical magnitude of the physical action to decide the virtual magnitude.

6. The interaction method of claim 1, wherein the posture classification comprises a fourth posture of positioning hands for typing, and adjusting the virtual magnitude comprises:
in response to that the physical action is identified as the fourth posture, reducing a physical magnitude of the physical action to decide the virtual magnitude.

7. The interaction method of claim 1, further comprises:
determining a target body part and a non-target body part according to the posture classification,
wherein adjusting the virtual magnitude further comprises:
adjusting the virtual magnitude corresponding to the physical action related to the target body part; and
keeping an unadjusted magnitude approximate to the physical action related to the non-target body part; and
wherein rendering the interaction effects further comprises:
applying the virtual magnitude after adjustment on the target body part on an avatar; and
applying the unadjusted magnitude approximate to the physical action onto the non-target body part on the avatar.

8. The interaction method of claim 1, wherein identifying the posture classification of the physical action further comprises:
detecting a current-running application;
obtaining an action set matched with the current-running application, the action set comprising a plurality of candidate postures while operating the current-running application; and
selecting the posture classification among the candidate postures.

9. The interaction method of claim 1, wherein adjusting the virtual magnitude comprises:
receiving a manual instruction;
in response to that the manual instruction indicates a first mode, amplifying a physical magnitude of the physical action to decide the virtual magnitude; and
in response to that the manual instruction indicates a second mode, reducing the physical magnitude of the physical action to decide the virtual magnitude.

10. A head-mounted display device, comprising:
a displayer, configured to display a virtual environment; and
a processor, coupled to the displayer, the processor being configured to:
track a head movement trajectory and a body movement trajectory;
recognize a physical action according to a relative movement between the head movement trajectory and the body movement trajectory;
identify a posture classification of the physical action;
adjust a virtual magnitude corresponding to the physical action according to the posture classification; and
render interaction effects between a virtual environment and a real environment according to the virtual magnitude after adjustment.

11. The head-mounted display device of claim 10, wherein the head-mounted display device further comprises a camera, the camera is configured to capture streaming images, the processor is coupled with the camera, the processor is configured to run a simultaneous localization and mapping (SLAM) algorithm to track the head movement trajectory based on the streaming images, and the processor is configured to run a computer vision algorithm to track the body movement trajectory.

12. The head-mounted display device of claim 10, wherein the head-mounted display device is communicated with a body-mounted tracker attached on a torso, a hand or a leg of a user, the processor is configured to track the body movement trajectory according to motion data generated by the body-mounted tracker.

13. The head-mounted display device of claim 10, wherein the posture classification comprises a first posture of leaning forward and running,
in response to that the physical action is identified as the first posture, the processor is configured to amplify a physical magnitude of the physical action to decide the virtual magnitude.

14. The head-mounted display device of claim 10, wherein the posture classification comprises a second posture of crouching in preparation to jump,
in response to that the physical action is identified as the second posture, the processor is configured to amplify a physical magnitude of the physical action to decide the virtual magnitude.

15. The head-mounted display device of claim 10, wherein the posture classification comprises a third posture of clenching a fist,
in response to that the physical action is identified as the third posture, the processor is configured to reduce a physical magnitude of the physical action to decide the virtual magnitude.

16. The head-mounted display device of claim 10, wherein the posture classification comprises a fourth posture of positioning hands for typing,
in response to that the physical action is identified as the fourth posture, the processor is configured to reduce a physical magnitude of the physical action to decide the virtual magnitude.

17. The head-mounted display device of claim 10, wherein the processor is further configured to:
determine a target body part and a non-target body part according to the posture classification;
adjust the virtual magnitude corresponding to the physical action related to the target body part;
keep an unadjusted magnitude approximate to the physical action related to the non-target body part;
apply the virtual magnitude after adjustment on the target body part on an avatar; and
apply the unadjusted magnitude approximate to the physical action onto the non-target body part on the avatar.

18. The head-mounted display device of claim 10, wherein the processor is further configured to:
detect a current-running application;
obtain an action set matched with the current-running application, the action set comprising a plurality of candidate postures while operating the current-running application; and
select the posture classification among the candidate postures.

19. The head-mounted display device of claim 10, wherein the processor is further configured to:
receive a manual instruction from a hand-held controller;
in response to that the manual instruction indicates a first mode, amplify a physical magnitude of the physical action to decide the virtual magnitude; and
in response to that the manual instruction indicates a second mode, reduce the physical magnitude of the physical action to decide the virtual magnitude.

20. A non-transitory computer-readable storage medium, storing at least one instruction program executed by a processor to perform an interaction method, the interaction method comprising:
tracking a head movement trajectory and a body movement trajectory;
recognizing a physical action according to a relative movement between the head movement trajectory and the body movement trajectory;
identifying a posture classification of the physical action;
adjusting a virtual magnitude corresponding to the physical action according to the posture classification; and
rendering interaction effects between a virtual environment and a real environment according to the virtual magnitude after adjustment.
